(19) United States
(12) Patent Application Publication
(10) Pub. No.: US 2020/0090057 A1
(43) Pub. Date: Mar. 19, 2020

(54) HUMAN-COMPUTER HYBRID DECISION METHOD AND APPARATUS

(71) Applicant: CLOUDMINDS (SHENZHEN) ROBOTICS SYSTEMS CO., LTD., Shenzhen (CN)

(72) Inventors: Shiguo LIAN, Beijing (CN); Zhaoxiang LIU, Beijing (CN); Kai WANG, Beijing (CN); Yimin LIN, Beijing (CN); Qiang LI, Beijing (CN)

(21) Appl. No.: 16/467,862

(22) PCT Filed: Dec. 7, 2016
(86) PCT No.: PCT/CN2016/108927

§ 371 Date: Jun. 7, 2019

(51) Int. Cl. G06N 5/04; G06N 20/00

(52) U.S. Cl. CPC G06N 5/04; G06N 20/00

(57) ABSTRACT

A human-computer hybrid decision method and apparatus, which relate to the field of artificial intelligence, are presented to solve the problem that it is difficult to ensure the system reliability by artificial intelligence alone. The method includes: determining a confidence coefficient of an artificial intelligence AI module for target information, wherein the confidence coefficient is used for indicating a probability that the AI module make a correct decision according to the target information; in response to the confidence coefficient being greater than a preset threshold, obtaining decision information made by the AI module according to the target information to serve as actual decision information; and in response to the confidence coefficient being less than the preset threshold, displaying the target information and providing an interaction interface; obtaining artificial decision information received by the interaction interface to serve as the actual decision information. The method is applied to artificial intelligence decision.

### FIELD OF THE INVENTION

The present disclosure relates to the field of artificial intelligence, and in particular, to a human-computer hybrid decision method and apparatus.

### BACKGROUND

The artificial intelligence (AI) technology is rapidly developing. Some capabilities have reached or exceeded the human and have been applied in many scenarios, for example, OCR (optical character recognition), speech recognition, face recognition and the like. The application of the artificial intelligence may reduce the repetitive works (for example, sweeping robots, intelligent monitoring and the like) of the human on one hand, and may provide assistance to the human even surpass the human (for example, intelligent power-assisted wearable device, robots playing the game of go and the like) on the other hand.

Although the artificial intelligence technology has demonstrated powerful capabilities, there are still some deficiencies in some aspects compared with the human, for example, unmanned driving (robots, cars, airplanes and the like) in complex environments, the grab and movement (service robots) of any objects and so on. The current artificial intelligence is difficult to guarantee 100% intelligence, such that it is very difficult to ensure the system reliability by artificial intelligence alone.

### SUMMARY OF THE INVENTION

The embodiment of the present disclosure provides a human-computer hybrid decision method and apparatus for mainly solving the problem that it is difficult to ensure the system reliability by artificial intelligence alone.

In order to achieve the above object, the embodiment of the present disclosure adopts the following technical solutions.

In a first aspect, the embodiment of the present disclosure provides a human-computer hybrid decision method, including:
determining a confidence coefficient of an artificial intelligence AI module for target information, wherein the confidence coefficient is used for indicating a probability that the AI module may make a correct decision according to the target information;in response to the confidence coefficient being greater than a preset threshold, obtaining decision information made by the AI module according to the target information to serve as actual decision information; and in response to the confidence coefficient being less than the preset threshold, displaying the target information and providing an interaction interface; and obtaining artificial decision information received by the interaction interface to serve as the actual decision information.

In a second aspect, the embodiment of the present disclosure provides a human-computer hybrid decision apparatus including:
a determining unit configured to determine a confidence coefficient of an artificial intelligence AI module for target information, wherein the confidence coefficient is used for indicating a probability that the AI module may make a correct decision according to the target information;
an obtaining unit configured to, in response to the confidence coefficient being greater than a preset threshold, obtain decision information made by the AI module according to the target information to serve as actual decision information; and
a display unit configured to, in response to the confidence coefficient being less than the preset threshold, display the target information and provide an interaction interface; and
wherein the obtaining unit is further configured to, in response to the confidence coefficient being less than the preset threshold, obtain artificial decision information received by the interaction interface to serve as the actual decision information.

In a third aspect, the embodiment of the present disclosure provides a computer storage medium for storing a computer software instruction used by a human-computer hybrid decision apparatus and containing a program code designed to execute the human-computer hybrid decision method in the first aspect.

In a fourth aspect, the embodiment of the present disclosure provides a computer program product, which is capable of being directly loaded in an internal memory of a computer and contains a software code, and the computer program may implement the human-computer hybrid decision method in the first aspect after being loaded and executed by the computer.

In a fifth aspect, the embodiment of the present disclosure provides a server including a memory, a communication interface and a processor, wherein the memory is configured to store a computer execution code, the processor is configured to execute the computer execution code to control the execution of the human-computer hybrid decision method in the first aspect, and the communication interface is configured to perform data transmission between the server and an external device.

According to the human-computer hybrid decision method and apparatus provided by the embodiment of the present disclosure, the confidence coefficient of using the AI module is obtained according to the target information. When the confidence coefficient is higher, the AI module directly makes a decision according to decision rules, and when the confidence coefficient is lower, an artificial decision is imported to generate decision information. Therefore, if it is judged that the AI module is difficult to make a correct decision, decision will be made by artificial intervention to ensure the reliability, such that the problem that it is very difficult to ensure the system reliability by artificial intelligence alone can be solved.

### BRIEF DESCRIPTION OF THE DRAWINGS

To illustrate technical solutions in the embodiments of the present disclosure or the prior art more clearly, a brief introduction on the drawings which are needed in the description of the embodiments or the prior art is given below. Apparently, the drawings in the description below are merely some of the embodiments of the present disclosure, based on which other drawings may be obtained by those of ordinary skill in the art without any creative effort.

FIG. 1 is a schematic diagram of a human-computer hybrid decision system provided by an embodiment of the present disclosure;

FIG. 2 is a schematic diagram of a human-computer hybrid decision method provided by an embodiment of the present disclosure;

FIG. 3 is a schematic diagram of another human-computer hybrid decision method provided by an embodiment of the present disclosure;

FIG. 4 is a schematic diagram of a human-computer hybrid decision apparatus provided by an embodiment of the present disclosure;

FIG. 5 is a schematic diagram of another human-computer hybrid decision apparatus provided by an embodiment of the present disclosure;

FIG. 6 is a schematic diagram of yet another human-computer hybrid decision apparatus provided by an embodiment of the present disclosure.

### DETAILED DESCRIPTION OF THE EMBODIMENTS

A clear and complete description of technical solutions in the embodiments of the present disclosure will be given below, in combination with the drawings in the embodiments of the present disclosure. Apparently, the embodiments described below are merely a part, but not all, of the embodiments of the present disclosure. All of other embodiments, obtained by those of ordinary skill in the art based on the embodiments of the present disclosure without any creative effort, fall into the protection scope of the present disclosure.

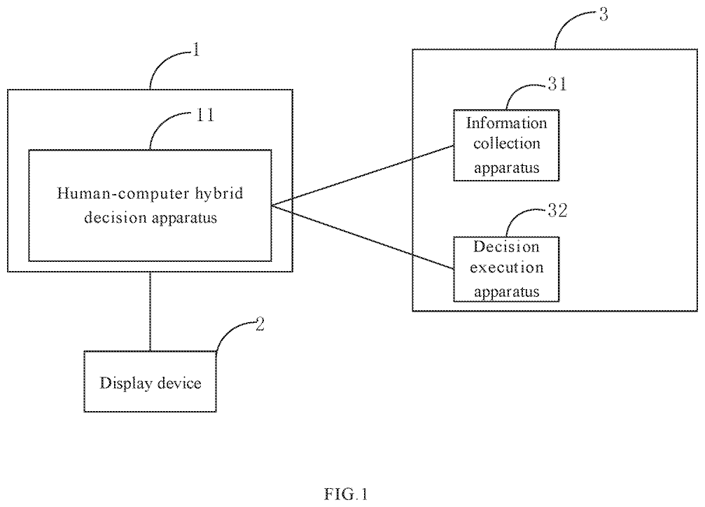

The embodiment of the present disclosure provides a human-computer hybrid decision system, as shown in FIG. 1, including: a server 1 and a corresponding display device 2 located in the cloud, and a terminal 3 located on site. The server 1 includes a human-computer hybrid decision apparatus 11. Depends on different actual application scenarios, the terminal 3 may be an intelligent device (for example, a mobile phone, glasses, a helmet or the like) that incorporates information collection and presentation, which may include an information collection apparatus 31 and a decision execution apparatus 32. The information collection apparatus 31 collects target information and sends the information to the server 1 in a wired (for example, a cable, a network cable) or a wireless (for example, WIFI, Bluetooth) mode, and displays the target information on the display device 2. The human-computer hybrid decision apparatus 11 of the server 1 sends a decision result to the decision execution apparatus 32 of the terminal 3 after making a decision according to the target information, wherein the target information includes, but is not limited to, sound, image, distance, light intensity, 3D and other information.

The human-computer hybrid decision apparatus 11 may include an AI module. The AI module may autonomously make decision under general conditions according to different decision rules contained in different application scenarios without artificial intervention, thereby saving manpower. For example, a sweeping robot plans a travel path according to a certain algorithm and the like. The decision rules may use non-intelligent algorithms or intelligent algorithms (such as a neural network algorithm). For the intelligent algorithms, a large amount of training needs to be performed on the decision rules, and adaptive learning may be performed in use. Under more complicated conditions, when the AI module cannot make a correct decision according to the existing decision rules, the artificial intervention is needed to make an artificial decision so as to improve the accuracy of the decision. At this time, information assistance may be provided for an operator to help artificial decision, and meanwhile, the operation or decision (for example, a voice command, mouse click and the like) of the operator is received. By combining the AI module with the artificial decision, the manpower is saved on one hand, and the accuracy of the decision is improved on the other hand.

The application scenarios of the embodiment of the present disclosure include, but are not limited to, intelligent blind guide, remote monitoring, remote unmanned aerial vehicle control, remote driving, remote operation (such as mining, surgery, mine clearance) and the like. In addition, the embodiment of the present disclosure may also be applied to the online promotion of intelligent algorithm, such as intelligent customer service or the like. For example, for a blind guidance system scenario, the information collection apparatus 31 may be a camera, a distance sensor or other information collection apparatus on a blind guide helmet, and the decision execution apparatus 32 may be a sound player or a tactile feedback mechanism on the blind guide helmet. The human-computer hybrid decision apparatus 11 obtains the target information from the blind guide helmet, generates the decision information according to the target information, and then transmits the decision information to the blind guide helmet for blind guide. Those skilled in the art may understand that the embodiment of the present disclosure is only illustrative of the above application scenarios, but is not intended to limit the application scope of the embodiment of the present disclosure.

According to the human-computer hybrid decision method, apparatus and system provided by the embodiment of the present disclosure, the confidence coefficient is determined after the target information is obtained through the AI module on the human-computer hybrid decision apparatus. When the confidence coefficient is higher, the AI module autonomously makes a decision, and when the confidence coefficient is lower, the artificial decision is imported to generate decision information, such that the problem that it is very difficult to ensure the system reliability by artificial intelligence alone at present can be solved.

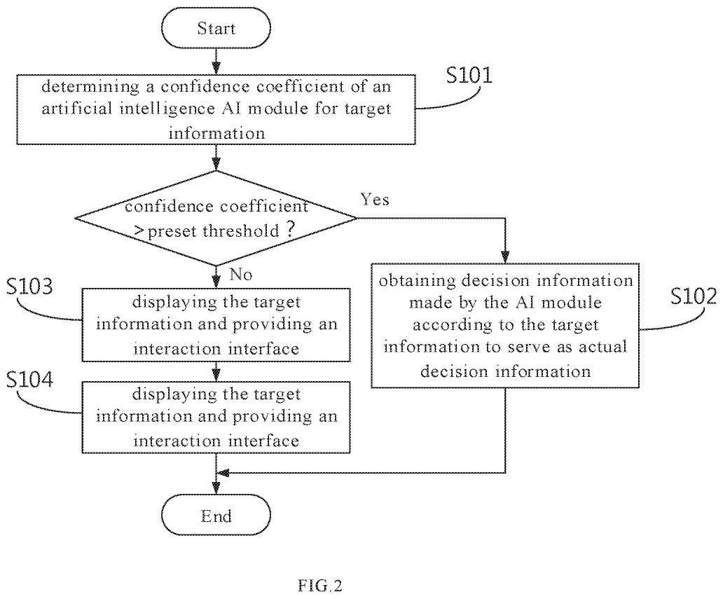

The embodiment of the present disclosure provides a human-computer hybrid decision method, as shown in FIG. 2, including the following steps.

S101: a confidence coefficient of an artificial intelligence AI module for target information is determined.

According to different application scenarios, the target information includes, but is not limited to, vision, hearing, distance, illumination and the like, and may also include 3D (three-dimensional) image information. Exemplarily, taking a blind guide helmet scenario as an example, the image information of the surrounding environment and obstacle distance information fed back by ultrasonic may be obtained for the positioning of blind guide decision, obstacle detection and the like.

The confidence coefficient is used for indicating a probability that the AI module may make a correct decision according to the target information. Different evaluation methods, such as similarity, classification probability and the like may be adopted according to different application scenarios. The confidence coefficient of the AI module is used for determining the priority of using the AI module or artificial decision to generate the decision information.

Taking the blind guide helmet scenario as an example, the target information is the information necessary for blind guide, and the AI module performs location positioning, obstacle detection, obstacle avoidance and other operations for the blind according to the target information, and also judges the confidence coefficient on its own ability in the process, for example, whether accurate positioning may be performed, whether obstacle avoidance may be performed and the like.

Exemplarily, whether itself may achieve accurate positioning may be judged by a positioning accuracy confidence coefficient, and the positioning accuracy confidence coefficient may be obtained by means of texture quality, number of tracking, quality of motion and the like, wherein the texture quality may be used for describing whether the features of the scenario are rich, whether the light is insufficient, whether it is occluded; the number of tracking may be used for describing the positioning quality of a vSLAM module; the quality of motion is used for describing the speed of the camera motion, and if the speed is too high, image blur is caused easily. When the positioning accuracy confidence coefficient obtained according to the above manner is higher than a preset threshold, it indicates that the AI module itself may achieve accurate positioning, or otherwise, it indicates that the AI module itself cannot achieve accurate positioning.

Exemplarily, whether itself may avoid an obstacle may be judged through an obstacle avoidance success confidence coefficient, and the obstacle avoidance success confidence coefficient may be used for analyzing a size ratio of a passable area in a scenario visual angle based on a depth reconstruction result through an obstacle avoidance algorithm. When the obstacle avoidance success confidence coefficient obtained according to the above manner is higher than a preset threshold, it indicates that the AI module itself may avoid the obstacle, or otherwise, it indicates that the AI module itself cannot avoid the obstacle.

S102: in response to the confidence coefficient being greater than a preset threshold, decision information made by the AI module according to the target information is obtained to serve as actual decision information.

The confidence coefficient of the AI module being greater than the preset threshold indicates that the AI module may make a correct decision according to the existing target information, so the AI module may be triggered to perform intelligent sensing and decision making according to the target information so as to generate the decision information.

Exemplarily, stilling taking the blind guide helmet scenario as an example, in response to the confidence coefficient of the AI module being greater than the preset threshold, the AI module identifies an object and gives the decision information (such as a navigation instruction) according to the image information of the surrounding environment or the obstacle distance information fed back by the ultrasonic, and automatically sends the decision information to the helmet. Exemplarily, the navigation instruction includes, but is not limited to, road walking prompt (move ahead, turn left, turn right, stop and the like), road information prompt (red light, stair, zebra crossing, car and the like) and life information prompt (people, object and the like).

S103: in response to the confidence coefficient being less than the preset threshold, the target information is displayed and an interaction interface is provided.

Specifically, when the target information includes 3D image information, in order to facilitate the artificial decision, auxiliary decision information may be generated, and the 3D image information in the target information is displayed in an AR (augmented reality) or VR (virtual reality) manner. The VR technology refers to that a computer generates an interactive three-dimensional environment to serve as a virtual environment, and three-dimensional images, sound and the like obtained by VR glasses may be presented to the operator, so that the operator may achieve the immersive experience, and the operator directly makes a decision; and the AR technology refers to a technology of calculating the location and angle of a camera image in real time and adding a corresponding image, video and three-dimensional model. Exemplarily, still taking the blind guide helmet scenario as an example, the location/visual angle of the blind, a planned path, surrounding obstacles, obstacle distance and other auxiliary information may be superimposed on a visual picture to provide decision support for the operator.

When the interaction interface is provided, for example, an interaction interface is displayed, and the interaction interface is used for receiving at least one type of artificial decision information; and/or, a sound collection device is triggered to collect voice.

S104: artificial decision information received by the interaction interface is obtained to serve as the actual decision information.

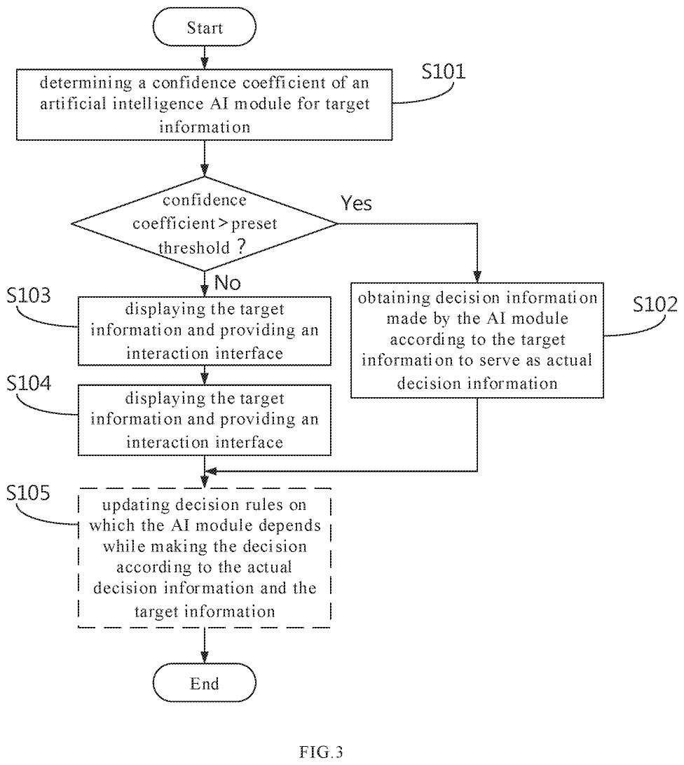

Optionally, referring to FIG. 3, after the actual decision information is generated in the steps S102 and S104, a step S105 may be further included.

S105: decision rules on which the AI module depends while making the decision are updated according to the actual decision information and the target information.

Through a feedback mechanism, the target information is combined with the corresponding decision information to optimize and enhance the decision rules, so that when similar or identical target information appears again, the AI module may make a decision according to the optimized decision rules, thereby further reducing the artificial intervention and achieving the goal of saving the manpower, meanwhile, with the increase in the number of samples, through continuous update and optimization, the decision rules are more perfect. Specifically, the decision information and the target information may be formed into a training data pair, and then the decision rules are trained according to the training data pair so as to update the decision rules.

Exemplarily, still taking the blind guide helmet scenario as an example, in an artificial blind guide process, the actual decision information of the artificial intervention is used as annotation information of the data and forms the training data pair with the target information, so that the decision rules are trained according to the training data pair so as to update the decision rules. For example, in the artificial blind guide process, the prompt (label) of road information and life information together with the corresponding visual picture (sample image) are collectively used as the training data pair (sample image, label) of an object recognition algorithm (decision rule); or, the prompt message (label) of road walking together with the corresponding visual picture (sample image) are used as the training data pair (sample image, label) of an obstacle avoidance algorithm (decision rule).

In the human-computer hybrid decision method provided by the embodiment of the present disclosure, the confidence coefficient of using the AI module is obtained according to the target information. When the confidence coefficient is higher, the AI module directly makes a decision according to the decision rules, and when the confidence coefficient is lower, the artificial decision is imported to generate the decision information. Therefore, when it is judged that the AI module is difficult to make a correct decision, decision is made by artificial intervention, the reliability is ensured by artificial decision, and the problem that it is very difficult to ensure the system reliability by artificial intelligence alone is solved.

Those skilled in the art will readily appreciate that the present disclosure may be implemented by hardware or a combination of hardware and computer software in combination with the units and algorithm steps of the various examples described in the embodiments disclosed herein. Whether a certain function is implemented in the form of hardware or driving the hardware via the computer software is determined by specific applications and design constraint conditions of the technical solutions. Those skilled in the art may implement the described functions by using different methods for each specific application, but this implementation should not be considered beyond the scope of the present disclosure.

The embodiment of the present disclosure may divide the function modules of the human-computer hybrid decision apparatus according to the above method example. For example, each function module may be divided for each function. Alternatively, two or more functions may also be integrated into one processing module. The above integrated module may be implemented in the form of hardware or a software function module. It should be noted that the division of the modules in the embodiment of the present disclosure is schematic and is only a logical function division, and other division manners may be provided during the actual implementation.

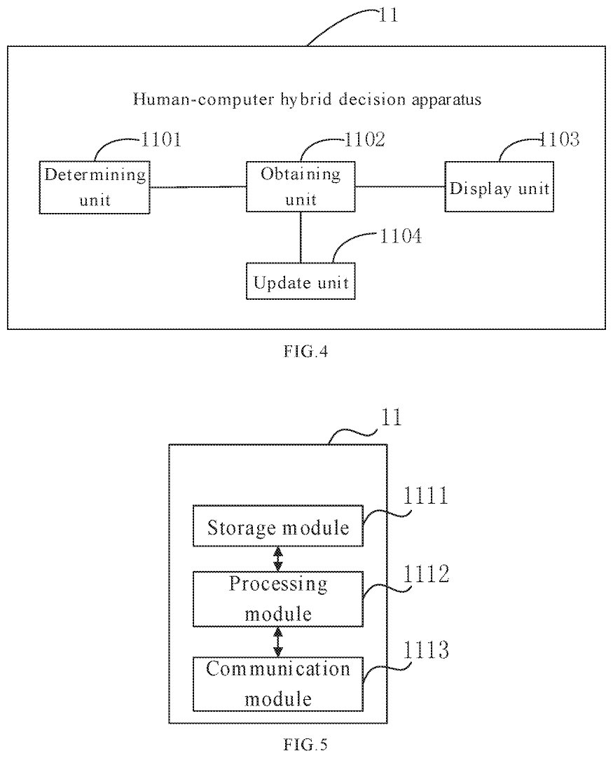

In the case that each function module is divided for each function, FIG. 4 shows a possible structural schematic diagram of the human-computer hybrid decision apparatus involved in the above embodiment. The human-computer hybrid decision apparatus 11 includes: a determining unit 1101, an obtaining unit 1102, a display unit 1103 and an update unit 1104. The determining unit 1101 is configured to support the human-computer hybrid decision apparatus to execute the process S101 in FIG. 2 and the process S101 in FIG. 3; the obtaining unit 1102 is configured to support the human-computer hybrid decision apparatus to execute the processes S102 and S104 in FIG. 2 and the processes S102 and S104 in FIG. 3; the display unit 1103 is configured to support the human-computer hybrid decision apparatus to execute the process S103 in FIG. 2 and the process S103 in FIG. 3; and the update unit 1104 is configured to support the human-computer hybrid decision apparatus to execute the process S105 in FIG. 3. All the related contents of the steps involved in the foregoing method embodiment may be quoted to the function descriptions of the corresponding function modules, and thus details are not described herein again.

In the case of that the integrated unit is adopted, FIG. 5 shows a possible structural schematic diagram of the human-computer hybrid decision apparatus involved in the above embodiment. The human-computer hybrid decision apparatus 11 includes a processing module 1112 and a communication module 1113. The processing module 1112 is configured to perform control and management on the actions of the human-computer hybrid decision apparatus, for example, the processing module 1112 is configured to support the human-computer hybrid decision apparatus to execute the processes S101-S104 in FIG. 2 and the processes S101-S105 in FIG. 3, and/or, is configured to execute other processes of the technology described herein, and the communication module 1113 is configured to support the communication between the human-computer hybrid decision apparatus and other network entities, for example, the communication between the function modules or network entities shown in FIG. 1. The human-computer hybrid decision apparatus 11 may further include a storage module 1111 configured to store a program code and data of the human-computer hybrid decision apparatus.

The processing module 1112 may be a processor or a controller, for example, may be a central processing unit (CPU), a general purpose processor, a digital signal processor (DSP), an application-specific integrated circuit (ASIC), a field programmable gate array (FPGA) or other programmable logic devices, transistor logic devices, hardware components or any combinations thereof. The processing module may implement or execute logic boxes, modules and circuits of various examples described in combination with the contents disclosed by the present disclosure. The processor may also be a combination for implementing a computing function, for example, a combination including one or more microprocessors, a combination of a DSP and a microprocessor, and the like. The communication module 1113 may be a transceiver, a transceiver circuit or a communication interface and the like. The storage module 1111 may be a memory.

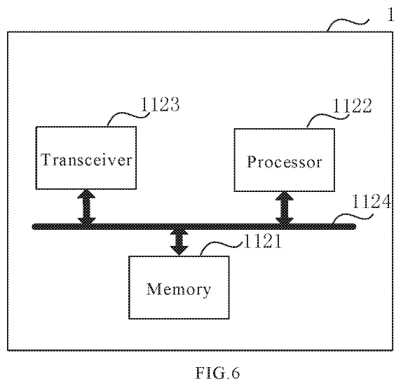

When the processing module 1112 is the processor, the communication module 1113 is the transceiver, and the storage module 1111 is the memory, the human-computer hybrid decision apparatus involved in the embodiment of the present disclosure may be the server as shown in FIG. 6.

As shown in FIG. 6, the server 1 includes a processor 1122, a transceiver 1123, a memory 1121 and a bus 1124. The transceiver 1123, the processor 1122 and the memory 1121 are connected to each other through the bus 1124. The bus 1124 may be a peripheral component interconnect (PCI) bus or an extended industry standard architecture (EISA) bus or the like. The bus may be divided into an address bus, a data bus, a control bus and the like. For the ease of representation, the bus is only expressed by a thick line in FIG. 6, but it does not mean that there is only one bus or one type of bus.

The steps of the method or algorithm described in combination with the contents disclosed by the present disclosure may be implemented in the form of hardware and may also be implemented by a processor executing software instructions. The embodiment of the present disclosure further provides a storage medium, the storage medium may include a memory 1121 configured to store a computer software instruction used by the human-computer hybrid decision apparatus, and the computer software instruction includes a program code designed to execute the human-computer hybrid decision method. Specifically, the software instruction may be composed of corresponding software modules, the software modules may be stored in a random access memory (RAM), a flash memory, a read only memory (ROM), an erasable programmable read-only memory (erasable programmable ROM, EPROM), an electrically erasable programmable read-only memory (electrically EPROM, EEPROM) or any other form of storage medium known in the art. An exemplary storage medium is coupled to the processor, so that the processor may read information from and write information to the storage medium. Of course, the storage medium may also be a constituent part of the processor. The processor and the storage medium may be located in an ASIC. Additionally, the ASIC may be located in the human-computer hybrid decision apparatus. Of course, the processor and the storage medium may also exist as discrete components in the human-computer hybrid decision apparatus.

The embodiment of the present disclosure further provides a computer program, the computer program may be directly loaded into the memory 1121 and contains a software code, and the computer program may implement the above human-computer hybrid decision method after being loaded and executed by a computer.

The foregoing descriptions are merely specific embodiments of the present disclosure, but the protection scope of the present disclosure is not limited thereto. Any skilled one who is familiar with this art could readily think of variations or substitutions within the disclosed technical scope of the present disclosure, and these variations or substitutions shall fall within the protection scope of the present disclosure. Accordingly, the protection scope of the present disclosure should be subject to the protection scope of the claims.

1. A human-computer hybrid decision method, comprising:
determining a confidence coefficient of an artificial intelligence AI module for target information, wherein the confidence coefficient is used for indicating a probability that the AI module can make a correct decision according to the target information;
in response to the confidence coefficient being greater than a preset threshold, obtaining decision information made by the AI module according to the target information to serve as actual decision information; and
in response to the confidence coefficient being less than the preset threshold, displaying the target information and providing an interaction interface; and obtaining artificial decision information received by the interaction interface to serve as the actual decision information.

2. The method according to claim 1, wherein after the obtaining artificial decision information received by the interaction interface to serve as the actual decision information, the method further comprises:
updating decision rules on which the AI module depends while making the decision according to the actual decision information and the target information.

3. The method according to claim 2, wherein the updating decision rules on which the AI module depends while making the decision according to the actual decision information and the target information comprises:
forming a training data pair in accordance with the actual decision information and the target information; and
training the decision rules according to the training data pair so as to update the decision rules.

4. The method according to claim 1, wherein the in response to the confidence coefficient being greater than a preset threshold, obtaining decision information made by the AI module according to the target information to serve as actual decision information comprises:
in response to the confidence coefficient being greater than the preset threshold, triggering the AI module to generate the decision information according to the target information; and obtaining the decision information made by the AI module according to the target information to serve as the actual decision information.

5. The method according to claim 1, wherein the target information comprises 3D image information;
the displaying the target information comprises:
displaying the 3D image information in the target information in an augmented reality AR or virtual reality VR manner.

6. The method according to claim 1, wherein the target information is information necessary for blind guide.

7. The method according to claim 1, wherein the providing an interaction interface comprises:
displaying an interaction interface, wherein the interaction interface is used for receiving at least one type of artificial decision information;
and/or, triggering a sound collection device to collect voice.

8. (canceled)

9. (canceled)

10. (canceled)

11. (canceled)

12. (canceled)

13. (canceled)

14. (canceled)

15. The computer storage medium configured to store a computer software instruction used by a human-computer hybrid decision apparatus, and comprising a program code designed for executing the human-computer hybrid decision method according to claim 1.

16. (canceled)

17. The server, comprising a memory, a communication interface and a processor, wherein the memory is configured to store a computer execution code, and the processor is configured to execute the computer execution code to control the execution of the human-computer hybrid decision method according to claim 1, and the communication interface is configured to perform data transmission between the server and an external device.
